(19) United States
(12) Patent Application Publication
(10) Pub. No.: US 2014/0147027 A1
(43) Pub. Date: May 29, 2014

(54) INTRA-OPERATIVE IMAGE CORRECTION FOR IMAGE-GUIDED INTERVENTIONS

(71) Applicants: Ameet Kumar Jain, New York, NY (US); Christopher Stephen Hall, Hopewell Junction, NY (US)

(72) Inventors: Ameet Kumar Jain, New York, NY (US); Christopher Stephen Hall, Hopewell Junction, NY (US)

(73) Assignee: KONINKLIJKE PHILIPS N.V., EINDHOVEN (NL)

(21) Appl. No.: 14/127,608

(22) PCT Filed: Jun. 27, 2012
(86) PCT No.: PCT/IB2012/053238

§ 371 Date: Dec. 19, 2013

Related U.S. Application Data
(60) Provisional application No. 61/503,666, filed on Jul. 1, 2011.

(51) Int. Cl. G06T 5/00

(52) U.S. Cl. CPC G06T 5/002
USPC 382/131

(57) ABSTRACT

An imaging correction system includes a tracked imaging probe (132) configured to generate imaging volumes of a region of interest from different positions. An image compensation module (115) is configured to process image signals from a medical imaging device associated with the probe and to compare one or more image volumes with a reference to determine aberrations between an assumed wave velocity through the region of interest and a compensated wave velocity through the region of interest. An image correction module (119) is configured to receive the aberrations determined by the image compensation module and generate a corrected image for display based on the compensated wave velocity.

This disclosure relates to image correction and more particularly to systems and methods for correcting accuracy errors in intra-operative images.

Ultrasonic (US) images are known to be distorted due to differences between assumed and actual speed of sound in different tissues. A US system assumes an approximate constant speed of sound. Many methods exist that try to correct for this assumption. In so doing, most methods look to the US wave information returning from anatomical features being imaged. Since a single US image does not include much intrinsic anatomical information, most of these methods have been unable to correct aberrations due to the constant speed assumption.

In procedures where the US image is used only for diagnostic purposes, phase aberration does not pose a serious problem. However, in US guided interventions, the US image is tightly correlated to an externally tracked surgical tool. Typically, the location of a tool tip is overlaid on the US image/volume. The tools are usually tracked using an external tracking system (e.g., electromagnetic, optical, etc.) in absolute spatial coordinates. In such a scenario, the US image aberration can have up to 5 mm of offset from a region of interest. This can add a large error to the overall surgical navigation system.

In accordance with the present principles, an imaging correction system includes a tracked imaging probe configured to generate imaging volumes of a region of interest from different positions. An image compensation module is configured to process image signals from a medical imaging device associated with the probe and to compare one or more image volumes with a reference to determine aberrations between an assumed wave velocity through the region of interest and a compensated wave velocity through the region of interest. An image correction module is configured to receive the aberrations determined by the image compensation module and generate a corrected image for display based on the compensated wave velocity.

A workstation in accordance with the present principles includes a processor and memory coupled to the processor. An imaging device is coupled to the processor to receive imaging signals from an imaging probe. The imaging probe is configured to generate imaging volumes of a region of interest from different positions. The memory includes an image compensation module configured to process image signals from the imaging device and compare one or more image volumes with a reference to determine aberrations between an assumed wave velocity through the region of interest and a compensated wave velocity through the region of interest. An image correction module also in memory is configured to receive the aberrations determined by the image compensation module and generate a corrected image for display based on the compensated wave velocity.

A method for image correction includes tracking an imaging probe to generate imaging volumes of a region of interest from different known positions; processing image signals from a medical imaging device associated with the probe to compare one or more image volumes with a reference to determine aberrations between an assumed wave velocity through the region of interest and a compensated wave velocity through the region of interest; and correcting the image signals to reduce the aberrations and to generate a corrected image for display based on the compensated wave velocity.

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

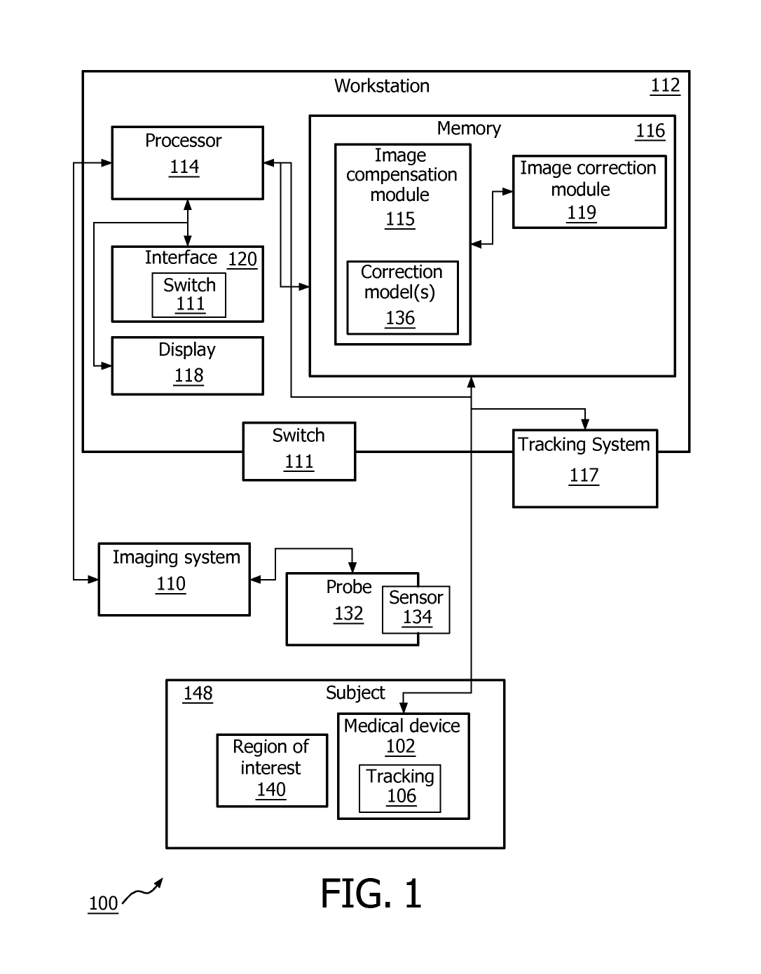

FIG. 1 is a block/flow diagram showing a system/method for correction aberration in medical images in accordance with one illustrative embodiment;

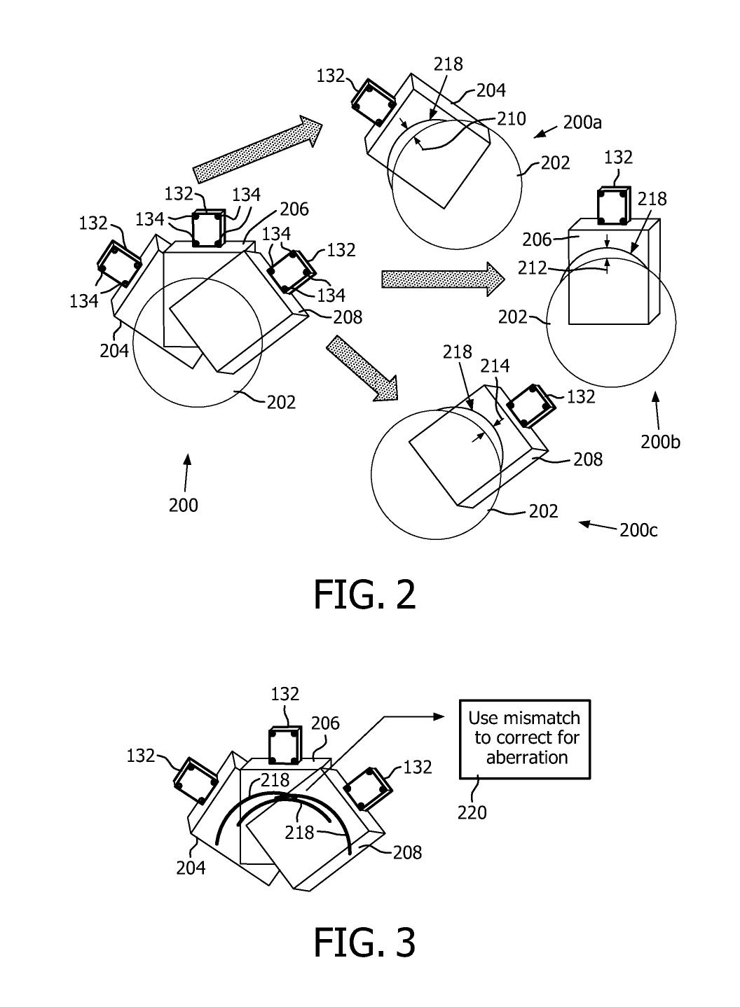

FIG. 2 is a schematic diagram showing a decomposition of image volumes taken at three different positions by an imaging probe in accordance with an illustrative example;

FIG. 3 is a schematic diagram showing image mismatches employed for correcting for aberrations in accordance with an illustrative embodiment;

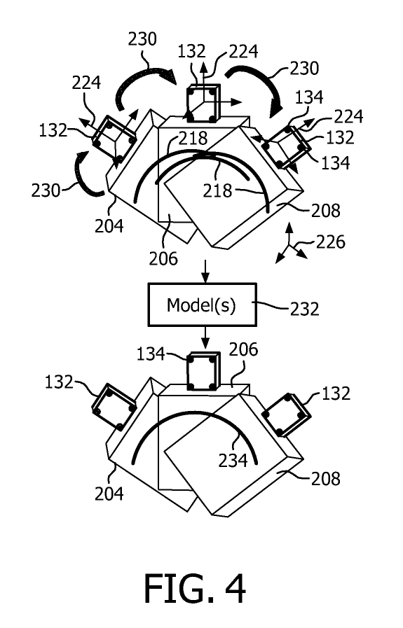

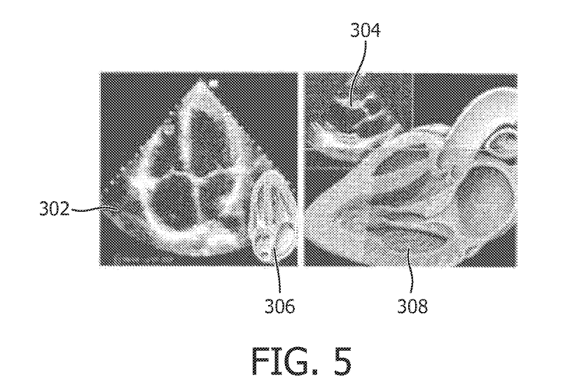

FIG. 4 is a schematic diagram showing a model employed to evaluate image mismatches for correcting for aberrations in accordance with another illustrative embodiment;

FIG. 5 shows images of models employed to evaluate mismatches with collected images for correcting for aberrations in accordance with another illustrative embodiment;

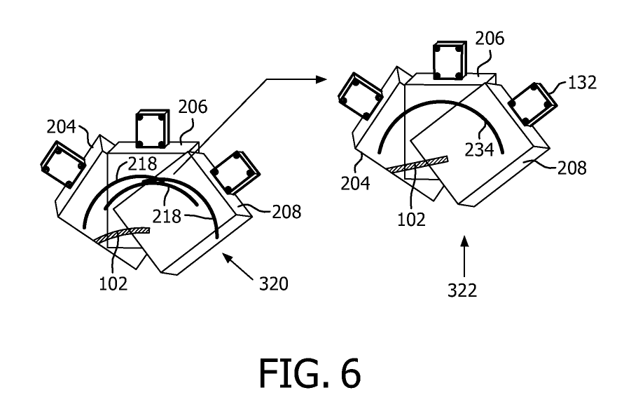

FIG. 6 is a schematic diagram showing a medical device employed to measure and correct image mismatches for aberrations in accordance with another illustrative embodiment; and

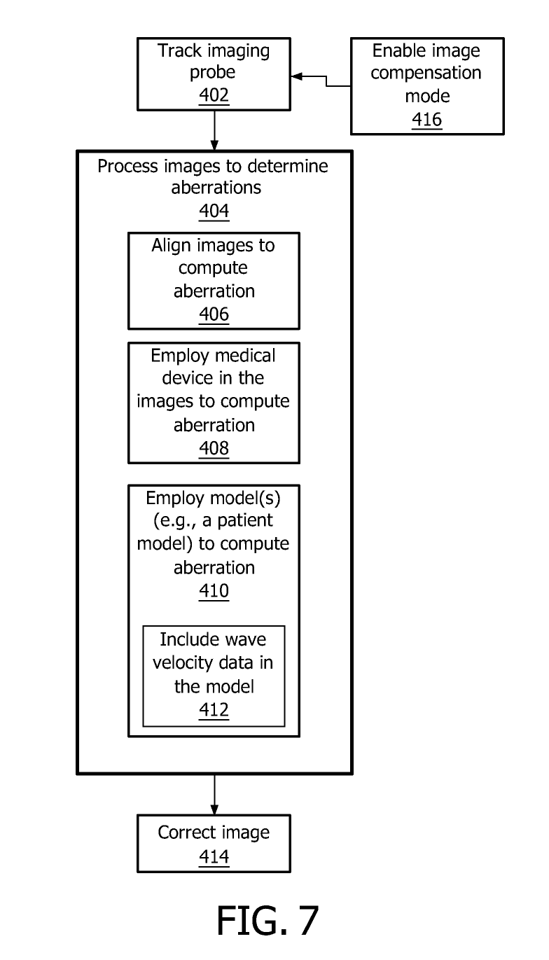

FIG. 7 is a flow diagram showing steps for correcting aberrations in medical images in accordance with one illustrative embodiment.

The present principles account for differences in the speed of sound waves travelling through a patient's anatomy. A difference in the speed of sound was experimentally shown to be consistently adding 3-4% error in an ultrasound (US) based navigation system (e.g., 4 mm error at a depth of 15 cm). The present embodiments correct for this error. When corrected using a speed of sound adjustment, the present principles reduced the overall error of the system. In one instance, the error was significantly reduced to about 1 mm from about 4 mm (at a depth of 15 cm).

For ultrasound based surgical navigation systems that are employed for interventional procedures, real-time tracked three-dimensional (3D) locations of a US image are employed, together with information from the image to correct for phase aberration. This increases the accuracy of any US-guided interventional system.

It is to be understood that the present invention will be described in terms of medical instruments; however, the teachings of the present invention are much broader and are applicable to any instruments employed in tracking or analyzing complex biological or mechanical systems. In particular, the present principles are applicable to internal tracking procedures of biological systems, procedures in all areas of the body such as the lungs, gastro-intestinal tract, excretory organs, blood vessels, etc. The elements depicted in the FIGS. may be implemented in various combinations of hardware and software and provide functions which may be combined in a single element or multiple elements.

The functions of the various elements shown in the FIGS. can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), non-volatile storage, etc.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams and the like represent various processes which may be substantially represented in computer readable storage media and so executed by a computer or processor, whether or not such computer or processor is explicitly shown.

Furthermore, embodiments of the present invention can take the form of a computer program product accessible from a computer-usable or computer-readable storage medium providing program code for use by or in connection with a computer or any instruction execution system. For the purposes of this description, a computer-usable or computer readable storage medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Referring now to the drawings in which like numerals represent the same or similar elements and initially to FIG. 1, a system 100 for performing a medical procedure is illustratively depicted. System 100 may include a workstation or console 112 from which a procedure is supervised and managed. Procedures may include any procedure including but not limited to biopsies, ablations, injection of medications, etc. Workstation 112 preferably includes one or more processors 114 and memory 116 for storing programs and applications. It should be understood that the function and components of system 100 may be integrated into one or more workstations or systems.

Memory 116 may store an image compensation module 115 configured to interpret electromagnetic, optical and/or acoustic feedback signals from a medical imaging device 110 and from a tracking system 117. The image compensation module 115 is configured to use the signal feedback (and any other feedback) to account for errors or aberrations related to velocity differences between an assumed velocity and an actual velocity for imaging a subject 148 and to depict a region of interest 140 and/or medical device 102 in medical images.

The medical device 102 may include, e.g., a needle, a catheter, a guide wire, an endoscope, a probe, a robot, an electrode, a filter device, a balloon device or other medical component, etc. Workstation 112 may include a display 118 for viewing internal images of a subject 148 using the imaging system 110. The imaging system 110 may include imaging modalities where wave travel velocity is at issue, such as, e.g., ultrasound, photoacoustics, etc. The imaging system or systems 110 may also include other systems as well, e.g., a magnetic resonance imaging (MRI) system, a fluoroscopy system, a computed tomography (CT) system or other system. Display 118 may permit a user to interact with the workstation 112 and its components and functions. This is further facilitated by an interface 120 which may include a keyboard, mouse, a joystick or any other peripheral or control to permit user interaction with the workstation 112.

One or more tracking devices 106 may be incorporated into the device 102, so tracking information can be detected at the device 102. The tracking devices 106 may include electromagnetic (EM) trackers, fiber optic tracking, robotic positioning systems, etc.

Imaging system 110 may be provided to collect real-time intra-operative imaging data. The imaging data may be displayed on display 118. Image compensation module 115 computes aberration corrections for the images/image signals returned from imaging system 110. A digital rendering of the region of interest 140 and/or the device 102 (using feedback signals) can be displayed with aberrations and errors accounted for due to traveling velocity differences. The digital rendering may be generated by an image correction module 119.

In one embodiment, the imaging system 110 includes an ultrasonic system, and the emissions are acoustic in nature. In other useful embodiments, an interventional application may include the use of two or more medical devices inside of a subject 148. For example, one device 102 may include a guide catheter, and another device 102 may include a needle for performing an ablation or biopsy, etc. Other combinations of devices are also contemplated.

In accordance with one particularly useful embodiment, a special operation mode may be provided on the workstation 112 or on the medical imaging device 110 (e.g., a US machine) to correct aberration in collected images. The special operation mode may be set by activating an enabling mechanism 111, e.g., an actual switch, button, etc. or a virtual switch, button, etc. (e.g., on interface 120). The switch 111 in the form of a button/or user interface can selectively be turned on or off manually or automatically. Once activated, the special operation mode enables phase aberration correction by employing a combination of feedback information from the imaging system 110 (e.g., US imaging system) and the tracking system 117.

In one embodiment, the imaging system 110 includes an ultrasonic system having a probe 132 with tracking sensors 134 mounted thereon. The tracking sensors 134 on the probe 132 are calibrated/registered to/with the volume being imaged. In this way, the region or interest 140 and/or medical device 102 is tracked by the tracking system 117 using sensors 134 and/or sensors 106 (for device 102). The sensors 134 on the US probe 132 provide a 3D position and orientation of the US image/volume in 3D space. Hence, with respect to a global coordinate system, the location of any voxel in any US image can be correlated to any other pixel in any other image.

The image compensation module 115 includes phase aberration correction models 136. The correction models 136 are correlated/compared to/with the collected images and employed to provide corrections for each of image. In one embodiment, the models 136 are employed to correlate information in one image to that observed in another image. This may be performed by matching corresponding features across the two (or more) images and optimizing the aberration correction model 136 to achieve a best fit model or models to the imaging data. In another embodiment, module 115 may employ image warping (e.g., using non-rigid registration of images) on two or more images to obtain a spatially-varying correction for the speed of sound (in addition to just a single corrected speed of sound).

The image compensation module 115 uses the feedback across multiple images and employs corrected properties thereafter for phase aberration correction. The image compensation module 115 ensures that the anatomy in these images lines up consistently across the multiple images. This is employed as a constraint by module 115 to correct for the aberration.

In another embodiment, the process for updating the ultrasound velocity may be performed iteratively where the corrected speed of sound is applied and then the procedure is performed again to further refine the speed of sound. This may be accomplished by manually or automatically guiding a user to move the probe 132 by a pre-defined amount or in a predefined direction. This can also be achieved algorithmically by running the algorithm multiple times on the corrected US images. Once the correction is obtained the images are updated in accordance with the corrected speed of sound.

In other embodiments, models 136 may include common or expected phase aberration distortion/correction values based on historic data, user inputs, image warping or learned phase aberration distortion/correction data. The correction models 136 can be as simple as a scaling operation (e.g., multiple a response by a scaling factor) in some cases, to more complicated anatomy based phase correction in other cases (e.g., accounting for distortions due to masses in the images, etc.).

Model optimization may employ a plurality of metrics in different combinations. For example, the correction model 136 may be optimized by computing an image matching metric, such as e.g., maximization of mutual information, minimization of entropy, etc. Alternately, the aberration may be optimized by utilizing the US image signals received for each image, and then matching those responses with the signals received from a different orientation. In yet another embodiment, the image compensation module 115 may register a current image(s) to a patient model (e.g., a pre-operative magnetic resonance image (MRI), computed tomography (CT) image, statistical atlas, etc.) and use that information to optimize the phase aberration.

One advantage of using a model 136 is that the optimization can use an ‘expected’ signal response from the model 136. Moreover, the model 136 can incorporate the expected speed of sound of the different tissues. Hence, the model aids in the live correction of the distortions of the US image.

A location of the externally tracked surgical tool/device 102 may also be employed as a constraint for correction. This is particularly useful if part of the device 102 (e.g., needle, catheter, etc.) is visible in the US image, as is usually the case in many applications. It should be noted that the herein-described and other techniques may be employed in combination with each other.

After the correction is applied, each US image will have voxels and depths of the voxels corrected to permit correct overlay of the surgical tools. The overlay of the tools is computed from the external tracking system 117. The image correction module 119 adjusts the image to account for the aberrations for outputting to a display 118 or displays.

In one example, in experiments carried out by the inventors, the inventors were able to repeatedly show that the difference of speed of sound was consistently adding 3-4% error in the US based navigation system (e.g., 4 mm error at a depth of 15 cm). In this case, the difference between the speed of sound assumed by the US machine and that in water was 4%. This led to an error in the calibration of the image volume to the sensors 134 attached to the probe 132, leading to a visible offset in the overlay of a catheter tip position of device 102. When correcting for the same using a speed of sound adjustment in accordance with the present principles, we were able to reduce the overall error of the system in this example by about 3 mm out of the 4 mm. These results are illustrative, other improvements are also contemplated. The method for correction reduces the amount of error phase aberration added to a US guided interventional system. The correction can significantly remove image bias, increase the accuracy of the system and correct distorted images. The present principles significantly improve the accuracy of interventional guidance systems and can bring image accuracy from being off by an average of 5-6 mm (unacceptable) to only 2-3 mm (acceptable) or less.

Referring to FIG. 2, an ultrasonic imaging process is decomposed to further illustrate the present principles. A region of interest 202 is to be imaged. A diagram 200 shows an ultrasonic probe 132 that includes sensors 134 to determine a position and orientation of the probe 132. As the probe 132 is positioned relative to the region of interest 202, a plurality of image volumes 204, 206 and 208 are collected. Diagrams 200a, 200b and 200c show a decomposition of the image 200. Each volume 204, 206, 208 in diagrams 200a, 200b and 200c includes an image 218 of the region of interest 202 that includes an aberration difference 210, 212 and 214 due to the difference between an assumed speed of sound and the actual speed of sound through the region of interest 202. The aberration differences 210, 212, 214 will be accounted for in accordance with the present principles.

Referring to FIG. 3, in one embodiment, the images 218 of each volume 204, 206, 208 can be compared against each other to determine mismatches between the images 218.

The mismatches are then employed to account for the aberration (210, 212, and 214) in block 220.

Referring to FIG. 4, the process of block 220 is described in greater detail in accordance with one particularly useful embodiment. The external probe 132 is tracked by sensors 134. A coordinate system 224 of the probe 132 can be transformed using transforms 230 to a coordinate system of the region of interest 202 or other reference coordinate system, e.g., a global coordinate system 226 associated with preoperative images taken by, e.g., CT, MRI, etc. The sensors 134 on the probe 132 provide the 3D position and orientation of the image volumes 204, 206 and 208 in 3D space. With respect to the global coordinate system 226, the location of any voxel in any image volume 204, 206 and 208 can be correlated to that of any other pixel in any other image volume.

A phase aberration correction model 232 takes these correlated images 218 and corrects each of the images 218. An algorithm correlates information in one image to that observed in another image by matching corresponding features across the two (or more) images. The correlation can be optimized by searching for a best fit correlation between the two or more images 218. The algorithm includes phase aberration distortion/correction models (e.g. scaling models, voxel models considering density of tissues and their variations, etc.). Phase aberration distortion/correction models may be employed to provide a best fit correlation 234 and/or represent historic data or other information learned for fitting two or more images. Model optimization can employ a variety of metrics in different combinations. For example, optimizing the correction model 232 may be performed by computing an image matching metric like maximization of mutual information, minimization of entropy, etc.

Referring to FIG. 5, in another embodiment, instead of or in addition to optimizing the aberration by utilizing US signals received for each image, and then matching the responses with the signals received from some other orientation, a current US image(s) 302 or 304 may be respectively registered or matched to a patient model(s) 306 or 308 (pre-operative MRI, CT, statistical atlas, etc.) and information collected for the registration/match may be employed to optimize the phase aberration. The models 306, 308 may be employed to provide an ‘expected’ signal response. For example, densities and geometries may be accounted for in terms of impact on sound velocity through features. The model(s) 306, 308 may incorporate the expected speed of sound of the different tissues, and aid in the live correction of the distortions in the images 302, 304.

Referring to FIG. 6, a tracked surgical tool, e.g., device 102, may be employed in another correction method. It should be understood that the present methods may be employed in addition to, in combination with or instead of the other methods described herein. A location of the externally tracked surgical tool 102 may be performed using a tracking system (117, FIG. 1), such as an electromagnetic tracking system, a fiber optic tracking system, a shape sensing system, etc. Since the device 102 is being tracked, the device 102 can be employed as a feature against which aberrations may be estimated and corrected. The position of the device 102 may be employed as a constraint for correction. This is particularly helpful if part of the device (e.g. a needle, catheter, etc.) is visible in the image volume (204, 206, 208), which is usually the case in many applications. A configuration 320 shows the device 102 with aberrations and a configuration 322 shows the device 102 after correction.

Referring to FIG. 7, a system/method for image correction is illustratively shown. In block 402, an imaging probe is tracked to generate imaging volumes of a region of interest from different known positions. The imaging probe may include an ultrasonic probe that sends and receives ultrasonic pulses or signals to/from a region of interest. The region of 3 0 interest may be any internal tissue or organs of a patient. Other imaging technologies may also be employed. The probe may be tracked using one of more position sensors. The position sensors may include electromagnetic sensors or may employ other position sensing technology.

In block 404, image signals are processed from a medical imaging device associated with the probe to compare one or more image volumes with a reference. The comparison determines aberrations between an assumed wave velocity (which is assumed to be constant for all tissues) through the region of interest and a compensated wave velocity through the region of interest.

In block 406, the reference may include one or more features of the region of interest and a plurality of image volumes from different orientations are aligned using a coordinate system such that mismatches in the one or more features are employed to compute the aberration. In block 408, a tracked medical device may be deployed in the images such that a position and orientation of the medical device may be employed as the reference to compute the aberration.

In block 410, the reference may include a model. One or more features of the region of interest are compared with the model such that feature mismatches are employed to compute the aberration. The model may include a patient model generated in advance by a three-dimensional imaging modality (e.g., CT, MRI, etc.). The model may also include selected feature points stored in memory to provide the comparison or transform to align images. The selected feature points may be determined or provided based on historic or learned data from the current procedure and/or procedures with other patients. In block 412, in one embodiment, the model may include wave velocity data through the region of interest (including different values for specific tissues, regions, etc.) and provide adjustments using this data to determine the compensated wave velocity through the region of interest.

In block 414, the image signals are corrected to reduce the aberrations and to generate a corrected image for display based on the compensated wave velocity. In block 416, an image compensation mode may be enabled by including a real or virtual switch to display an aberration corrected image when activated. When activated, the switch enables aberration compensation. When disabled, the aberration compensation is not compensated.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) no specific sequence of acts is intended to be required unless specifically indicated.

Having described preferred embodiments for systems and methods for intra-operative image correction for image-guided interventions (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the embodiments disclosed herein as outlined by the appended claims. Having thus described the details and particularity required by the patent laws, what is claimed and desired protected by Letters Patent is set forth in the appended claims.

1. An imaging correction system, comprising:
a tracked imaging probe (132) configured to generate imaging volumes of a region of interest from different positions;
an image compensation module (115) configured to process image signals from a medical imaging device associated with the probe and compare one or more image volumes with a reference to determine aberrations between an assumed wave velocity through the region of interest and a compensated wave velocity through the region of interest; and
an image correction module (119) configured to receive the aberrations determined by the image compensation module and generate a corrected image for display based on the compensated wave velocity.

2. The system as recited in claim 1, wherein the reference includes one or more features of the region of interest such that when a plurality of image volumes (204, 206, 208) from different orientations are aligned using a coordinate system, mismatches in the one or more features are employed to compute the aberration.

3. The system as recited in claim 1, wherein the reference includes a model (136) and one or more features of the region of interest are compared to the model such that mismatches in the one or more features are employed to compute the aberration.

4. (canceled)

5. The system as recited in claim 3, wherein the model (136) includes wave velocity data through the region of interest to provide the compensated wave velocity through the region of interest.

6. The system as recited in claim 1, further comprising a tracked medical device (102) wherein the medical device position and orientation are employed as the reference to compute the aberration.

7. The system as recited in claim 1, wherein the image compensation module (115) employs an optimization method to determine a best fit match between an image and the reference.

8. (canceled)

9. A workstation, comprising:
a processor (114);
memory (116) coupled to the processor; and
an imaging device (110) coupled to the processor to receive imaging signals from an imaging probe (132), the imaging probe configured to generate imaging volumes of a region of interest (140) from different positions;
the memory including:
an image compensation module (115) configured to process image signals from the imaging device and compare one or more image volumes with a reference to determine aberrations between an assumed wave velocity through the region of interest and a compensated wave velocity through the region of interest; and
an image correction module (119) configured to receive the aberrations determined by the image compensation module and generate a corrected image for display based on the compensated wave velocity.

10. (canceled)

11. (canceled)

12. (canceled)

13. (canceled)

14. The workstation as recited in claim 9, further comprising a tracked medical device (102) wherein the medical device position and orientation are employed as the reference to compute the aberration.

15. The workstation as recited in claim 9, wherein the image compensation module employs an optimization method to determine a best fit match between an image and the reference.

16. The workstation as recited in claim 15, wherein the optimization method includes one of maximization of mutual information and minimization of entropy.

17. The workstation as recited in claim 9, further comprising an enable mechanism (111) configured to enable an image compensation mode to display an aberration corrected image.

18. (canceled)

19. A method for image correction, comprising:
tracking (402) an imaging probe to generate imaging volumes of a region of interest from different known positions;
processing (404) image signals from a medical imaging device associated with the probe to compare one or more image volumes with a reference to determine aberrations between an assumed wave velocity through the region of interest and a compensated wave velocity through the region of interest; and
correcting (414) the image signals to reduce the aberrations and to generate a corrected image for display based on the compensated wave velocity.

20. The method as recited in claim 19, wherein the reference includes one or more features of the region of interest and the method further comprises aligning (406) a plurality of image volumes from different orientations using a coordinate system such that mismatches in the one or more features are employed to compute the aberration.

21. The method as recited in claim 19, wherein the reference includes a model and the method further comprises comparing (410) one or more features of the region of to the model such that mismatches in the one or more features are employed to compute the aberration.

22. (canceled)

23. (canceled)

24. The method as recited in claim 19, further comprising deploying (408) a tracked medical device such that a position and orientation of the medical device are employed as the reference to compute the aberration.

25. (canceled)
